(19) United States
(12) Patent Application Publication
(10) Pub. No.: US 2010/0278338 A1
(43) Pub. Date: Nov. 4, 2010

(54) CODING DEVICE AND METHOD WITH RECONFIGURABLE AND SCALABLE ENCRYPTION/DECRYPTION MODULES

(75) Inventors: Yu-Lin Chang, Hsin-Chu (TW); Wensheng Zhou, Los Angeles, CA (US)

Correspondence Address: Chen Yoshimura LLP;Attention Ying Chen, 333 W. El Camino Real, Suite 380, Sunnyvale, CA, 94087, US

(73) Assignee: MEDIATEK SINGAPORE PTE. LTD., Singapore (SG)

(21) Appl. No.: 12/435,349

(22) Filed: May 4, 2009

(51) Int. Cl. H04N 7/167; H04L 9/28; G06F 21/00

(52) U.S. Cl. 380/200; 380/28; 726/1

(57) ABSTRACT

A reconfigurable and scalable cryptography (encryption/decryption) system architecture and related method are described. The system utilizes a multiple-pass approach, each pass applying one cryptography algorithm with its own cryptography keys. The encrypted data can only be fully and correctly decrypted with the correct algorithms in the correct sequence (as determined by one or more security level parameters) and the correct cryptography keys. The system includes a multiple cryptography algorithm set section which is reconfigurable to perform multiple cryptography algorithms sequentially, and a cryptography controller which receives an input key set and a security level parameter. The cryptography controller reconfigures the multiple cryptography algorithm set section based on the security level parameter to perform multiple selected cryptography algorithms in a selected sequence. The cryptography controller also generates cryptography keys based on the input key set and provide the cryptography keys to the multiple cryptography algorithm set section.

### BACKGROUND OF THE INVENTION

1. Field of the Invention

This invention relates to encryption/decryption, and in particular, it relates to a reconfigurable and scalable encryption/decryption devices and methods.

2. Description of the Related Art

Encryption/decryption is widely used in electronic devices, such as devices used in telecommunications, network transmission, digital content distribution and sharing, content display, data storage, etc., to provide data security. Many encryption/decryption algorithms are known in the art.

### SUMMARY OF THE INVENTION

The present invention is directed to an encryption/decryption device and method that substantially obviates one or more of the problems due to limitations and disadvantages of the related art.

An object of the present invention is to provide an encryption/decryption device and method with enhanced security protection.

Another object of the present invention is to provide an encryption/decryption device and method with increased flexibility to users.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a cryptography system which includes: a multiple cryptography algorithm set section reconfigurable to perform a plurality of cryptography algorithms sequentially on input data; and a cryptography controller receiving an input key set and a security level parameter, the cryptography controller reconfiguring the multiple cryptography algorithm set section based on the security level parameter to perform a plurality of selected cryptography algorithms in a selected sequence, the cryptography controller further generating one or more cryptography keys based on the input key set and providing the cryptography keys to the multiple cryptography algorithm set section for performing the selected cryptography algorithms.

The multiple cryptography algorithm set section comprises one or more cryptography units, each cryptography unit implementing one or more cryptography algorithms and being reconfigurable to perform any one of the one or more cryptography algorithms.

The cryptography controller includes: a key processor receiving the input key set for generating the cryptography keys; and a controller receiving the security level parameters for reconfiguring the multiple cryptography algorithm set section based on the security level parameters, the controller receiving the cryptography keys from the key processor and selectively providing the cryptography keys to the multiple cryptography algorithm set section based on the security level parameter.

In another aspect, the present invention provides a cryptography method implemented on a cryptography system, which includes: (a) receiving input data; (b) receiving, by a cryptography controller, an input key set and one or more security level parameters; (c) generating, by a cryptography controller, a plurality of cryptography keys based on the input key set; and (d) performing, by a multiple cryptography algorithm set section, a plurality of selected cryptography algorithms in a selected sequence on the input data, wherein the selected cryptography algorithms or the selected sequence or both are determined by the security level parameter, and wherein the selected cryptography algorithms are performed using the plurality of cryptography keys.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a reconfigurable and scalable multiple-pass encryption system and method according to an embodiment of the present invention.

FIG. 2 schematically illustrates a reconfigurable and scalable multiple-pass decryption system and method according to an embodiment of the present invention.

FIG. 3 illustrates an exemplary key processor used in the encryption system of FIG. 1 or the decryption system of FIG. 2.

FIGS. 4a and 4b illustrate two alternative structures of a reconfigurable encryption/decryption module according to embodiments of the present invention.

FIG. 5 is a schematic block diagram illustrating a multimedia data processing system incorporating the multiple-pass encryption/decryption according to an embodiment of the present invention.

### DETAILED DESCRIPTION OF THE PREFERRED EMBODIMENTS

Conventional encryption/decryption systems have various weaknesses. In many conventional systems, only one or a fixed number of encryption/decryption algorithms can be applied to each data. Such a fixed encryption/decryption algorithm scheme cannot fulfill users' desire to protect their data with variable security levels. Also, if attackers know which algorithms are used, they can focus on attacking the particular algorithms.

Embodiments of the present invention provide a reconfigurable and scalable encryption/decryption system architecture and related method that utilize a multiple-pass approach, each pass applying one encryption/decryption algorithm with its own encryption/decryption keys. The encrypted data can only be fully and correctly decrypted with the correct algorithms in the correct sequence (as determined by one or more security level parameters) and the corresponding encryption/decryption keys. With incorrect algorithm set or encryption/decryption keys, the data cannot be decrypted or can only be partially decrypted. Multiple-pass encryption/decryption provides higher data invulnerability. In addition, the security level of the overall method can be variable depending on the number of passes, providing flexibility of data protection to equipment manufacturers and end users.

As used in this disclosure, the term “cryptography” encompasses both encryption and decryption. For example, cryptography keys may refer to encryption keys or decryption keys or both, cryptography algorithms may refer to encryption algorithms or decryption algorithms or both, a cryptography unit (described in detail later) may refer to a unit that performs encryption or decryption or both, etc.

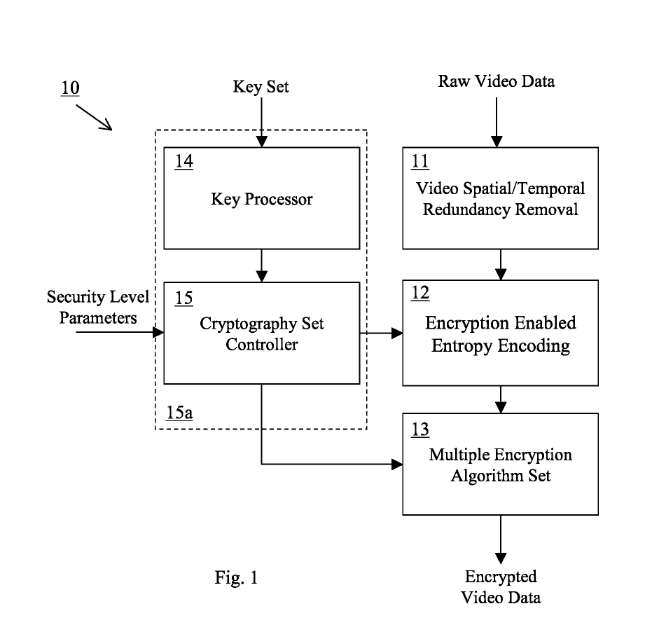

FIG. 1 schematically illustrates a reconfigurable and scalable multiple-pass encryption system 10 and a corresponding method according to an embodiment of the present invention. In this example, the raw data to be encrypted is video data, but similar methods and structures can be applied to other types of data with appropriate modifications. As shown in FIG. 1, the video data is first processed for spatial and/or temporal redundancy removal by a spatial/temporal redundancy removal section 11. The data is then entropy encoded by an encryption enabled entropy encoding section 12. Spatial/temporal redundancy removal and entropy encoding are compression processes well known in the field of video data processing. The encryption enabled entropy encoding section 12 may apply encryption during entropy encoding, but encryption is optional in this step. For example, the encryption enabled entropy coding section 12 may implement encryption using randomized Huffman table coding or randomized arithmetic coding. In randomized Huffman table coding, a plurality of isomorphic Huffman tables are either pre-stored or dynamically generated, and one of the Huffman tables is selected based on a key hopping sequence to encode each symbol. In randomized arithmetic coding encryption, one of a plurality of coding conventions is selected based on the key hopping sequence to code each symbol. The entropy encoded data is inputted to a multiple encryption algorithm set section 13 which performs multiple-pass encryption, i.e., a number of encryption algorithms performed sequentially, on the data to generate encrypted video data. Of course, if the raw data is not video or image data, the spatial/temporal redundancy removal section 11 and the encryption enabled entropy encoding section 12 may not be necessary, and the raw data may be inputted directly to the multiple encryption algorithm set section 13.

The multiple encryption algorithm set section 13 is reconfigurable to perform a number of selected encryption algorithms in a selected order or sequence. It includes one or more encryption units which are pipelined (either in space or in time) to perform the sequence of encryption algorithms. Each encryption unit implements one or more encryption algorithms and can be configured and reconfigured to perform any one of the algorithms at a given time. The encryption algorithms implemented by the encryption units may be algorithms known in the art or algorithms that may be developed in the future. Examples of known encryption algorithms include selective encryption, VEA (video encryption algorithm), RPB (random rotation in partitioned blocks), AES, DES, etc.

The multiple encryption algorithm set section 13 is configured by a cryptography set controller 15. The cryptography set controller 15 controls which encryption units within the multiple encryption algorithm set section 13 are selected in the pipeline and their order, and what encryption algorithm is performed by each selected encryption unit. This control is based on one or more security level parameters inputted to the cryptography set controller 15. Any suitable algorithm may be implemented in the cryptography set controller 15 to determine which encryption algorithms to use and in what order for given security level parameters. Generally, a higher security level requires more passes (more encryption algorithms) to be applied. The input security level parameters themselves may be encrypted, and the cryptography set controller 15 decrypts the parameter.

In the system shown in FIG. 1, the encryption enabled entropy encoding section 12 operates in a pipeline fashions with the multiple encryption algorithm set section 13, which can prevent a differential power analysis attack on the standard encryption algorithm such as DES and AES. As mentioned earlier, the encryption enabled entropy encoding section 12 is optional.

The encryption keys used by the encryption enabled entropy encoding section 12 and the multiple encryption algorithm set section 13 are generated by a key processor 14 and provided to the sections 12 and 13 by the cryptography set controller 15. The key processor 14 receives an input key set (which includes one or more input keys, and the number of input keys is flexible) and generates the encryption keys. The encryption keys may be in any suitable form as required by the corresponding encryption algorithms. For example, the encryption enabled entropy encoding section 12 may require key hopping sequences to implement randomized Huffman table coding. All such information needed for the encryption and coding algorithms is collectively referred to as encryption keys in this disclosure unless otherwise specified.

The key processor 14 may implement any suitable algorithm to generate the encryption keys. Preferably, the key processor 14 is programmable, and the algorithms used to generate the encryption keys can be changed by programming. Preferably, the key processor 14 is programmable to require more or fewer input keys in the input key set, which increases flexibility and enhances security.

The key processor 14 shown in FIG. 1 does not receive the security level parameters. Thus, the key processor 14 generates encryption keys for all encryption algorithms offered by the multiple encryption algorithm set section 13 and the encryption enabled entropy encoding section 12. The cryptography set controller 15 manages the encryption keys and selects the encryption keys to output to the multiple encryption algorithm set section 13 and the encryption enabled entropy encoding section 12 based on what encryption algorithms are performed, which is determined by the security level parameters.

As an alternative structure (not shown), the key processor 14 receives the security level parameters as an input, and selectively generates only the encryption keys that will be used by the multiple encryption algorithm set section 13 and the encryption enabled entropy encoding section 12 based on the security level parameters. As another alternative structure, the key processor 14 and the cryptography set controller 15 are combined into a cryptography controller 15a (indicated by the dashed box in FIG. 1) which receives the input key set and security level parameters and performs both encryption key management and reconfiguration of the multiple encryption algorithm set section 13. The controller 15a configures the multiple encryption algorithm set section 13 based on the security level parameters, generates encryption keys based on the input key set and the security level parameters, and provides them to the multiple encryption algorithm set section 13 and the encryption enabled entropy encoding section 12.

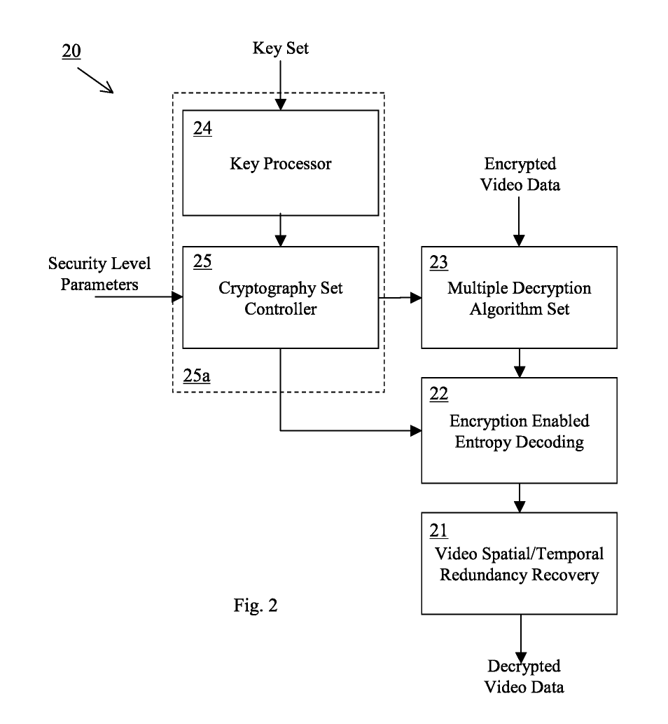

FIG. 2 schematically illustrates a reconfigurable and scalable multiple-pass decryption system 20 and a corresponding method according to an embodiment of the present invention. In this example, the system decrypts video data encrypted by the encryption system shown in FIG. 1. The decryption system includes a multiple decryption algorithm set section 23 which is reconfigurable to perform a number of selected decryption algorithms in a selected order or sequence. The video data generated by the multiple decryption algorithm set section 23 is inputted to an encryption enabled entropy decoding section 22 which performs an encryption enabled entropy decoding algorithm corresponding to the encoding algorithm in the encryption enabled entropy encoding section 12 of FIG. 1. The entropy decoded data is then processed by a video spatial/temporal redundancy recovery section 21 to recover the spatial and/or temporal redundancy removed during the encoding process to generate decrypted video data for output.

A cryptography set controller 25 receives one or more security level parameters and configures the multiple decryption algorithm set section 23 based on the security level parameters, such that the sequence of the decryption algorithms performed by the multiple decryption algorithm set section 23 is the reverse of the sequence of the corresponding encryption algorithms used to encrypt the data. Similar to the multiple encryption algorithm set section 13, the multiple decryption algorithm set section 23 includes one or more decryption units which are pipelined (either in space or in time) to perform the sequence of decryption algorithms. Each decryption unit implements one or more decryption algorithms and can be configured and reconfigured to perform any one of the algorithms at a given time. The cryptography set controller 25 controls which decryption units within the multiple decryption algorithm set section 23 are selected in the pipeline and their order, and what algorithm is performed by each decryption unit.

A key processor 24 receives an input key set (typically it is identical to the input key set for the encryption system 10) and generates decryption keys based on the input key set, and the cryptography set controller 25 provides the appropriate decryption keys to the encryption enabled entropy decoding section 22 and the multiple decryption algorithm set section 23 based on the security level parameters. In a similar manner as the alternative structures described above for the key processor 14 in FIG. 1, the key processor 24 may receive the security level parameters and only generate the necessary decryption keys based on the security level parameters, or the key processor 24 and the cryptography set controller 25 may be combined into one cryptography controller 25a (indicated by the dashed box in FIG. 2).

The multiple-pass encryption/decryption system 10 and 20 of the embodiments of the present invention enhances the invulnerability of data. To correctly decrypt the encrypted data, the decryption system 20 must receive the correct security level parameters (which may themselves be encrypted) and the correct input key set. If incorrect security level parameters are inputted, incorrect algorithms and/or an incorrect algorithm sequence will be applied, and the data will not be correctly decrypted.

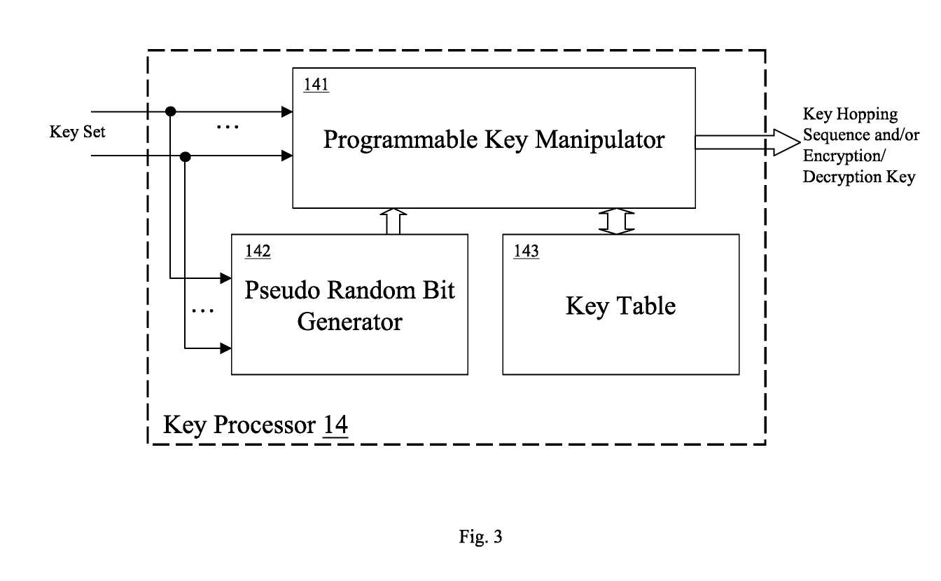

FIG. 3 illustrates an example of the key processor 14 of the encryption system of FIG. 1. This key processor 14 generates encryption keys needed for the encryption algorithms performed by the multiple encryption algorithm set section 13 as well as key hopping sequences needed by the encryption enabled entropy encoding section 12. The processor 14 includes a programmable key manipulator 141, a pseudo random bit generator 142, and a key table 143. The pseudo random bit generator 142 generates pseudo random bits based on the input key set, and the programmable key manipulator 141 generates the key hopping sequences using the pseudo random bits. The key table 143 contains pre-stored keys, and the programmable key manipulator 141 generates the encryption keys based on the input key set and pre-stored keys selected from key table 143. The programmable key manipulator 141 may implement any suitable algorithm to generate the key hopping sequences and the encryption keys. The key manipulator 141 is programmable, and the algorithms used to generate the key hopping sequences and the encryption keys can be changed by programming the key manipulator 141. The pseudo random bit generator 142 and the key manipulator 141 may be programmed to require more or fewer input keys in the input key set, which increases flexibility and enhances security.

The structure of the key processor 24 of the decryption system of FIG. 2 is similar or identical to the key processor 14 of the encryption system. The encryption keys and decryption keys may be the same keys and generated from the input key set in the same way.

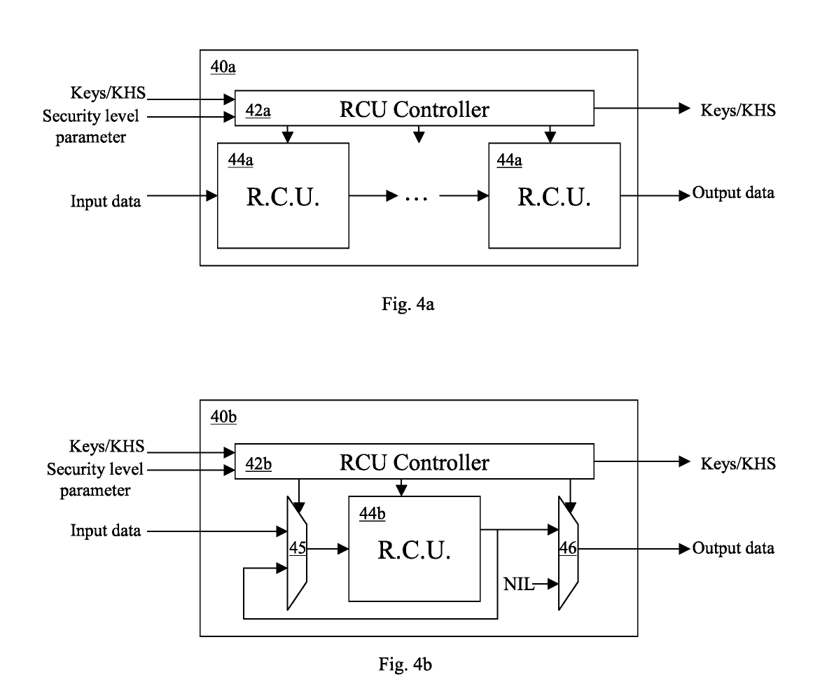

FIGS. 4a and 4b illustrate two alternative structures of a reconfigurable cryptography module 40a/40b that implements the cryptography set controller 15 and the multiple encryption algorithm set section 13 of FIG. 1, or the cryptography set controller 25 and the multiple decryption algorithm set section 23 of FIG. 2. In FIGS. 4a and 4b, the RCU (reconfigurable cryptography unit) controller 42a/42b corresponds to the cryptography set controller 15 or 25 in FIG. 1 or 2, and the collections of RCUs (reconfigurable cryptography units) 44a and the RCU 44b with the multiplexers 45 and 46 correspond to the multiple encryption algorithm set section 13 in FIG. 1 or the multiple decryption algorithm set section 23 in FIG. 2.

The structure in FIG. 4a employs a cascade architecture where a number of RCUs 44a are physically connected together in a pipeline. In some embodiments, each RCU 44a is reconfigurable to perform any one of a set of cryptography algorithms at a given time, and can be reconfigured to perform different cryptography algorithms at different times. Such RCUs are practical because many cryptography algorithms have similar algorithmic elements and an RCU can be made so that its hardware circuit components can be shared by many algorithms while making the unit reconfigurable to selectively perform one of many algorithms. Based on the inputted security level parameters, the RCU controller 42a configures the RCUs 44a so that each RCU performs a selected cryptography algorithm (or performs no algorithm, i.e., an RCU can be bypassed). The RCU controller 42a also provides the corresponding cryptography keys to each RCU 44a. In this manner, the selected sequence of cryptography algorithms is performed on the input data to generate the output (encrypted or decrypted) data. In the cascade architecture, some RCUs may be non-reconfigurable (i.e. each such RCU performs only one cryptography algorithm), and they can be selected or bypassed by the RCU controller 42a for particular configurations.

The structure in FIG. 4b employs a loopback architecture using a single RCU 44b. The RCU 44b is reconfigurable to perform any one of multiple cryptography algorithms. Based on the inputted security level parameters, the RCU controller 42b configures the RCU 44b, provides appropriate cryptography keys to the RCU, and controls the first and second multiplexers 45 and 46 on a temporal basis to form a pipeline. In other words, the RCU 44b is reconfigured to perform a sequence of selected cryptography algorithms one at a time forming multiple processing stages, and the multiplexers 45 and 46 are controlled to feed the processing result of one stage back to the RCU 44b for the next stage processing.

For example, the RCU controller 42b first configures the RCU 44b to perform a first cryptography algorithm and provides the cryptography keys for the first algorithm; meanwhile, the RCU controller 42b controls the first multiplexer 45 to select the input data and controls the second multiplexer 46 to select NIL. Buffers are provided (either inside the RCU 44b or separately) to buffer the output data of the RCU 44b. Then, after the first stage processing is complete, the RCU controller 42b configures the RCU 44b to perform a second cryptography algorithm and provides the cryptography keys for the second algorithm; meanwhile, the RCU controller 42b controls the first multiplexer 45 to select the buffered previous (first) stage output data of the RCU 44b and controls the second multiplexer 46 to select NIL. Then, after the second stage processing is complete, the RCU controller 42b configures the RCU 44b to perform a third cryptography algorithm and provides the cryptography keys for the third algorithm; meanwhile, the RCU controller 42b controls the first multiplexer 45 to select the buffered previous (second) stage output data of the RCU 44b and controls the second multiplexer 46 to select the current (third) stage output of the RCU 44b. In this manner, the selected sequence of three cryptography algorithms is performed on the input data to generate the output (encrypted or decrypted) data.

The RCUs 44a and 44b may be encryption units or decryption units or encryption/decryption units that can be configured to perform either encryption or decryption. Thus, the reconfigurable cryptography module 40a/40b may be an encryption module or a decryption, or same hardware module may be reconfigured to perform either encryption or decryption. Thus, the same structure can be reconfigured and used for encryption in one device and for decryption in another device, or reconfigured and used for encryption and decryption (at different times) in the same device.

Comparing the two different architectures shown in FIGS. 4a and 4b, the cascade architecture allows the reconfigurable cryptography process to be executed in a faster speed, but it has a more complex structure (more RCUs) which occupies more chip area. The security level may also be more limited in the cascade architecture; for example, the number of passes is limited to the maximum number of RCUs in the physical pipeline. The loopback architecture is slower than the cascade architecture, but has a simpler structure (only one RCU) that occupies less chip area. The loopback architecture is also more flexible and more scalable since the security level is not limited by the physical number of RCUs. In the loopback architecture, the RCU 44b must be able to perform all of the encryption/decryption algorithms offered by the reconfigurable and scalable encryption/decryption method. In the cascade architecture, each RCU 44a can be made to perform one or several but not all of the encryption/decryption algorithms offered by the entire module.

In an alternative architecture, a reconfigurable cryptography module may include a mixed architecture, which includes both multiple RCUs physically arranged in a cascade structure as in FIG. 4a and one (or more) RCUs with multiplexers arranged in a loopback structure as in FIG. 4b. In another alternative architecture, a reconfigurable cryptography module may contain multiple RCUs connected in a way so that the data flow from one RCU to another is reconfigurable by the RCU controller. In this alternative, each RCU may be either reconfigurable or non-reconfigurable (i.e. performs only one algorithm), and the RCU controller reconfigures the connection order among them to select some RCUs in an order and bypass some other RCUs as desired.

In the structures shown in FIGS. 4a and 4b, the RCU controller 42a/42b receives cryptography keys and the security level parameters. In addition to supplying the cryptography keys to the RCUs 44a/44b, the RCU controller 42a/42b may also output cryptography keys to other components it controls (not shown in FIGS. 4a and 4b); for example, it may provide key hopping sequences to the encryption enabled entropy encoding or decoding section if one is employed.

The structures shown in FIGS. 1-4b may be implemented by hardware logic (e.g. ASIC) or processors executing firmware/software. The RCUs 44a/44b and the RCU controller 42a/42b may be integrated into a silicon-on-chip (SoC) structure.

Examples of cryptography algorithms that may be employed in the multiple-pass cryptography system described above include, for network communication (e.g. encryption algorithms applied to network data packets): RC5 (Rivest Cipher 5), DES (Data Encryption Standard), AES (Advanced Encryption Standard), etc.; for multimedia data content/container (e.g. encryption algorithms applied to multimedia content): XOR-based array scrambling (DCT, ME coefficient scrambling, etc.), selective encryption, VEA (video encryption algorithm), RPB (random rotation in partitioned blocks), MHT (multiple Huffman table), RAC (randomized arithmetic coding), REC (randomized entropy coding), etc. For transmission of multimedia data, one or more of the second group of algorithms above may be applied to encrypt the data content, and then one or more of the first group of algorithms may be applied to further encrypt the data for network transmission.

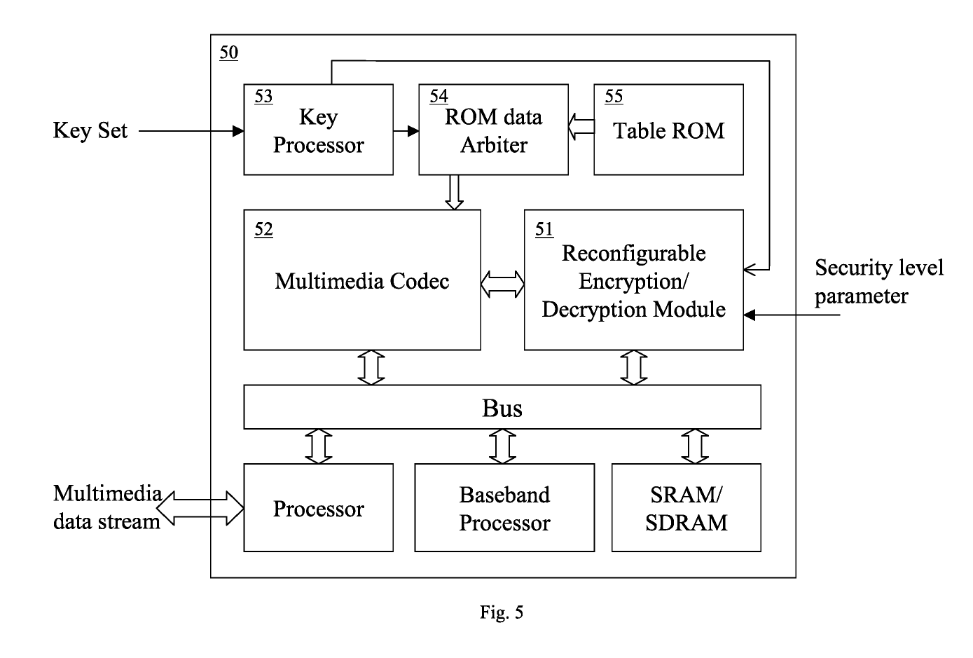

The multiple-pass cryptography system described above may be used in various practical applications, including but not limited to telecommunications, network transmission, digital content distribution and sharing, digital imaging devices such as digital cameras, content display devices including mobile playback devices, data storage, etc. One application example, a multimedia data processing system 50 incorporating the multiple-pass encryption/decryption system, is schematically shown in FIG. 5.

The system 50 may be implemented in an SoC structure. The reconfigurable cryptography module 51 corresponds to the module 40a/40b in FIGS. 4a and 4b. The multimedia codec 52 performs entropy encoding or decoding. The multimedia codec 52 obtains some of its parameters from the reconfigurable cryptography module 51. The key processor 53 (which may correspond to the key processor 14/24 in FIGS. 1 and 2) generates encryption or decryption keys based on the input key set. The ROM 55 stores code tables and other parameters for performing encryption enabled entropy encoding and decoding. A ROM data arbiter 54 provides permutation and randomization of the ROM data stored in the Table ROM 55. The ROM 55, the ROM data arbiter 54 and the multimedia codec 52, which may correspond to the encryption enabled entropy encoding and decoding sections 12 and 22 in FIGS. 1 and 2, implement the encryption enabled entropy encoding or decoding method. The other components of the system 50, namely, the processor, baseband processor and SRAM/SDRAM, are components typically found in conventional multimedia data processing systems and perform conventional functions.

The reconfigurable cryptography system architecture and method described above achieve scalable security level using different algorithm sets for different needs of the users. The system provides multiple different protection mechanisms, and protects the data at multiple possible weak points during distribution and sharing. It enhances the flexibility and invulnerability of the present multimedia SoC with encryption functions. It also provides equipment manufactures and end users flexibility in data protection, allowing them to choose a specific security level or designate a particular algorithm set to include in the multiple-pass cryptography system. A system providing a relatively small number of algorithms will occupy a relatively small area on the chip and consume relatively low power, but has relatively high risk; a system providing a relatively large number of algorithms have the opposite pros and cons.

Although the embodiments described herein use video and image data as examples, the reconfigurable and scalable encryption/decryption method may be applied to other types of data as well.

It will be apparent to those skilled in the art that various modification and variations can be made in the reconfigurable multiple-pass cryptography system and method of the present invention without departing from the spirit or scope of the invention. Thus, it is intended that the present invention cover modifications and variations that come within the scope of the appended claims and their equivalents.

What is claimed is:

1. A cryptography system comprising:
a multiple cryptography algorithm set section reconfigurable to perform a plurality of cryptography algorithms sequentially on input data; and
a cryptography controller receiving an input key set and one or more security level parameters, the cryptography controller reconfiguring the multiple cryptography algorithm set section based on the security level parameters to perform a plurality of selected cryptography algorithms in a selected sequence, the cryptography controller further generating one or more cryptography keys based on the input key set and providing the cryptography keys to the multiple cryptography algorithm set section for performing the selected cryptography algorithms.

2. The cryptography system of claim 1, wherein the cryptography algorithms are encryption algorithms, the cryptography system further comprising:
a redundancy removal section for performing spatial and/or temporal redundancy removal on input video data; and
an entropy encoding section for performing entropy encoding on video data outputted by the redundancy removal section,
wherein the multiple cryptography algorithm set section performs the encryption algorithms on video data outputted by the entropy encoding section.

3. The cryptography system of claim 1, wherein the cryptography algorithms are decryption algorithms, the cryptography system further comprising:
an entropy decoding section for performing entropy decoding on video data outputted by the multiple cryptography algorithm set section; and
a redundancy recovery section for performing spatial and/or temporal redundancy recovery on video data outputted by the entropy decoding section.

4. The cryptography system of claim 1, wherein the multiple cryptography algorithm set section comprises one or more cryptography units, each cryptography unit implementing one or more cryptography algorithms and being reconfigurable to perform any one of the one or more cryptography algorithms.

5. The cryptography system of claim 1, wherein the multiple cryptography algorithm set section comprises a plurality of cryptography units connected in a pipeline, each cryptography unit implementing one or more cryptography algorithms and being reconfigurable to perform any one of the one or more cryptography algorithms, and
wherein the cryptography controller reconfigures each cryptography unit to perform one of the selected cryptography algorithms or to perform no algorithm.

6. The cryptography system of claim 1, wherein the multiple cryptography algorithm set section comprises:
a cryptography unit implementing a plurality of cryptography algorithms and reconfigurable to perform any one of the plurality of cryptography algorithms; and
a first and a second multiplexer connected before and after the cryptography unit, respectively,
wherein the cryptography controller reconfigures the cryptography unit to perform the selected cryptography algorithms in the selected sequence one at a time forming multiple processing stages, and controls the first and second multiplexers to feed output of one stage back to the cryptography unit for a next stage.

7. The cryptography system of claim 1, wherein the cryptography controller uses a programmable algorithm to generate the cryptography keys and is programmable to require different numbers of input keys in the input key set.

8. The cryptography system of claim 1, wherein the cryptography controller comprises:
a key processor receiving the input key set for generating the cryptography keys; and
a controller receiving the security level parameters for reconfiguring the multiple cryptography algorithm set section based on the security level parameters, the controller receiving the cryptography keys from the key processor and selectively providing the cryptography keys to the multiple cryptography algorithm set section based on the security level parameters.

9. The cryptography system of claim 8, wherein the key processor comprises:
a key table containing a plurality of pre-stored keys; and
a programmable key manipulator for generating the cryptography keys based on the input key set and pre-stored keys selected from the key table.

10. The cryptography system of claim 9, wherein the cryptography keys includes a plurality of key hopping sequences, the key processor further comprises:
a pseudo random bit generator for generating pseudo random bits based on the input key set,
wherein the programmable key manipulator generates the key hopping sequences using the pseudo random bits generated by the pseudo random bit generator.

11. The cryptography system of claim 1, wherein the cryptography algorithms performed by the multiple cryptography algorithm set section are selected from a group comprising RC5, DES, AES, XOR-based array scrambling, selective encryption, VEA (video encryption algorithm), RPB (random rotation in partitioned blocks), MHT (multiple Huffman table), RAC (randomized arithmetic coding), REC (randomized entropy coding), and encryption enabled entropy encoding/decoding.

12. The cryptography system of claim 1, wherein the cryptography algorithms performed by the multiple cryptography algorithm set section include one or more cryptography algorithms for multimedia content and one or more cryptography algorithms for network communication.

13. The cryptography system of claim 1, wherein one or more security level parameters received by the cryptography controller are encrypted and the cryptography controller decrypts the security level parameters.

14. The cryptography system of claim 1, wherein the multiple cryptography algorithm set section and the cryptography controller are integrated into a silicon-on-chip (SoC) structure.

15. A cryptography method implemented on a cryptography system, comprising:
(a) receiving input data;
(b) receiving, by a cryptography controller, an input key set and one or more security level parameters;
(c) generating, by a cryptography controller, a plurality of cryptography keys based on the input key set; and
(d) performing, by a multiple cryptography algorithm set section, a plurality of selected cryptography algorithms in a selected sequence on the input data, wherein the selected cryptography algorithms or the selected sequence or both are determined by the security level parameters, and wherein the selected cryptography algorithms are performed using the plurality of cryptography keys.

16. The cryptography method of claim 15, further comprising, prior to step (d):
(e) performing, by a redundancy removal section, spatial and/or temporal redundancy removal on input video data; and
(f) performing, by an entropy encoding section, entropy encoding on video data generated by step (e),
wherein the cryptography algorithms in step (d) are encryption algorithms and are performed on video data generated by step (f).

17. The cryptography method of claim 15, wherein the cryptography algorithms in step (d) are decryption algorithms, the method further comprising, after step (d):
(e) performing, by an entropy decoding section, entropy decoding on video data generated by step (d); and
(f) performing, by a redundancy recovery section, spatial and/or temporal redundancy recovery on video data generated by step (e).

18. The cryptography method of claim 15, wherein step (c) comprises:
(c1) pre-loading a plurality of pre-stored keys in a key table; and
(c2) generating the cryptography keys based on the input key set and pre-stored keys selected from the key table.

19. The cryptography system of claim 18, wherein the cryptography keys includes a plurality of key hopping sequences, and wherein step (c) further comprises:
(c3) generating pseudo random bits based on the input key set; and
(c4) generating the key hopping sequences using the pseudo random bits.

20. The cryptography system of claim 15, wherein the plurality of cryptography algorithms are selected from a group comprising RC5, DES, AES, XOR-based array scrambling, selective encryption, VEA (video encryption algorithm), RPB (random rotation in partitioned blocks), MHT (multiple Huffman table), RAC (randomized arithmetic coding), REC (randomized entropy coding), and encryption enabled entropy encoding/decoding.
